(19) United States
(12) Patent Application Publication
(10) Pub. No.: US 2013/0201310 A1
(43) Pub. Date: Aug. 8, 2013

(54) SYSTEM FOR CONTROLLING IMAGE DATA OF IMAGE SENSOR FOR CAPSULE ENDOSCOPE

(71) Applicants: Han Jung, Daejeon (KR); Bong Ki Baek, Daejeon (KR); Yong Woo Lee, Daejeon (KR); Byung Hyuk Kim, Daejeon (KR); Chul Cha, Daejeon (KR); Sang Heun Park, Daejeon (KR)

(72) Inventors: Han Jung, Daejeon (KR); Bong Ki Baek, Daejeon (KR); Yong Woo Lee, Daejeon (KR); Byung Hyuk Kim, Daejeon (KR); Chul Cha, Daejeon (KR); Sang Heun Park, Daejeon (KR)

(73) Assignee: I3SYSTEM, INC., Daejeon (KR)

(21) Appl. No.: 13/880,273

(22) PCT Filed: Oct. 21, 2011
(86) PCT No.: PCT/KR2011/007893

§ 371 Date: Apr. 18, 2013

(30) Foreign Application Priority Data
Oct. 27, 2010 (KR) 10 2010 0105476

(51) Int. Cl. H04N 5/232

(52) U.S. Cl. CPC H04N 5/232
USPC 348/65

(57) ABSTRACT

The present invention relates to a system for controlling an image data of an image sensor for a capsule endoscope, and more particularly, to a system for controlling an image data of an image sensor for a capsule endoscope, which controls the image data of a capsule endoscope system in which operations are changed using two image sensors of a capsule endoscope that are identically designed and manufactured in order to capture images of the inside of the human body.

### TECHNICAL FIELD

The present invention relates to a system for controlling an image data of an image sensor for a capsule endoscope, and more particularly, to a system for controlling an image data of an image sensor for a capsule endoscope which controls the image data of a capsule endoscope system, in which operations are changed by means of two image sensors of a capsule endoscope that are identically designed and manufactured in order to capture images of the inside of the human body.

### BACKGROUND ART

An apparatus and a method for collecting video information among the various medical information of the inside of the human body are widely well-known. Recently, an endoscope of the capsule type has been developed from the general wire endoscope and it is used to diagnose different diseases in the medical field.

In the endoscope of the capsule type, in other words, the capsule endoscope, where the patient swallows it like the tablet, the video data of the digestive organ of the inside of the human body, which is caught through the camera of the endoscope, is transmitted to the external receiving device and it can play the video in the monitor.

The moving speed of the endoscope of the capsule type is different according to the motional characteristic of the digestive organ. Also, the photographic speed of the endoscope should be changed according to the difference of the moving speed.

For example, where the capsule type endoscope is quickly moved in the gullet, it is necessary to take a photograph at high speed so as to obtain the image information without loss. Meanwhile, where the capsule type endoscope is slowly moved in the small intestine in comparison with the gullet, since there are no many movements, it is necessary to slowly take a photograph so as to decrease an unnecessary data.

Thus, in the capsule endoscope in which operations are changed, in light of the motional characteristic of the digestive organ and the moving speed of the capsule, it photographs the image of the inside of the body and obtains the information thereof.

In order to easily examine the photographed images, it is necessary to unify the capsule photographing image, the operating speed of the capsule, and the information thereof to be displayed thereon.

Accordingly, by unifying the capsule photographing image, the operating speed of the capsule, and the information thereof, during the examination of the doctor, it is necessary to display the information such as a display method capable of easily checking out, the operating speed of the capsule, and the on/off status of the image sensor together with the photographing images of the inside of the human body.

### DISCLOSURE

### Technical Problem

Accordingly, the present invention has been made to solve the above-mentioned problems occurring in the prior art, and an object of the present invention is to provide a system for controlling an image data of an image sensor for a capsule endoscope in that capsule photographing images, an operating speed of the capsule, and information thereof are unified to be displayed, thereby easily examining the photographed images by means of a doctor, and especially the information such as an operating speed of the capsule and an on/off status of the image sensor is displayed with photographing images of the inside of a human body in the form of a bar graph so as to unify the photographed image of the inside of the body, the operating speed of the capsule, and the information thereof to be displayed thereon.

Another object of the present invention is to provide a system for controlling an image data of an image sensor for a capsule endoscope in that display regions such as a main view, a mini view, a state bar, and an image classification etc. are classified to be displayed, thereby efficiently examining the images by means of a user.

Further another object of the present invention is to provide a system for controlling an image data of an image sensor for a capsule endoscope in that it binds similar images together and characteristic images are listed during integrated classification of the images, so that the examination time of the doctor can be shortened.

Further another object of the present invention is to provide a system for controlling an image data of an image sensor for a capsule endoscope in that states (a photographic speed, a frame rate, a brightness, an organ indicators, a pH, a temperature etc.) of the entire photographed images is outputted according to the number of the image sensors into the bar type.

Further another object of the present invention is to provide a system for controlling an image data of an image sensor for a capsule endoscope in that the number of the classified image frame, an average brightness, and a color sense are displayed in the form of a vertical bar during integrated classification of the images and each image of the master image sensor and the slave image sensor is separately classified to be displayed without synchronizing the master image sensor and the slave image sensor.

### Technical Solution

In order to accomplish this object, there is provided a system for controlling an image data of an image sensor for a capsule endoscope having a master image sensor and a slave image sensor for photographing an inside of animal bodies including a human body according to one embodiment of the present invention comprising:

an image information receiving unit for receiving image information transmitted from the master image sensor and the slave image sensor;

an image separating unit for dividing images transmitted from the master image sensor and the slave image sensor by analyzing the image information received from the image information receiving unit;

a mini view processing unit for outputting the image divided by the image separating unit to a master display region and a slave display region;

a main view processing unit for enlarging and outputting the image by enabling a user to choose one image from the images outputted from the mini view processing unit;

a state information processing unit for outputting the state of the image according to a sensor into a bar type by analyzing the image information received from the image information receiving unit; and

a central control unit for controlling the signal flow of the image information receiving unit, the image separating unit, the mini view processing unit, the main view processing unit, and the state information processing unit.

### Advantageous Effects

According to the system for controlling the image data of the image sensor for the capsule endoscope, there is an effect in that the capsule photographing images, the operating speed of the capsule, and the information thereof are unified to be displayed, thereby easily examining the photographed images by means of a doctor, and especially the information such as the operating speed of the capsule and the on/off status of the image sensor is displayed with photographing images of the body in the form of the bar graph so as to unify the photographed image of the inside of the body.

Also, there is another effect in that the display regions such as a main view, a mini view, a state bar, and an image classification etc. are classified to be displayed, thereby efficiently examining the images by means of a user.

Moreover, there is further another effect in that it binds similar images together and characteristic images are listed during integrated classification of the images, so that the examination time of the doctor can be shortened.

Furthermore, there is further another effect in that the states (a photographic speed, a frame rate, a brightness, an organ indicators, a pH, a temperature etc.) of the entire photographed images is outputted according to the number of the image sensors into the bar type, thereby measuring an acidity of the human body, checking out the distribution of the organ images at a look, checking out the relationship between the symptoms of a disease and the body temperature by measuring the entire temperature of the body, utilizing it as the organ division by judging the exercise ability of the human body according to the measurement of the pressure, utilizing it as the examination of the organ activity and the motility thereof, and using it as the supplementary materials of the position recognition by distinguishing the master image sensor and the slave image sensor.

Furthermore, there is further another effect in that the number of the classified image frame, the average brightness, and the color sense are displayed in the form of the vertical bar during integrated classification of the images and each image of the master image sensor and the slave image sensor is separately classified to be displayed without synchronizing the master image sensor and the slave image sensor, thereby decreasing the examination time, the synchronization between the sensors can be freely adjusted, thereby analyzing the images, and it can intensively analyze the images in a short period of time by using one view mode.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a system for controlling an image data of an image sensor for a capsule endoscope according to one embodiment of the present invention;

FIG. 2 is an example view illustrating a display screen of a system for controlling an image data of an image sensor for a capsule endoscope according to one embodiment of the present invention;

FIG. 3 is an example view illustrating a main view screen of a system for controlling an image data of an image sensor for a capsule endoscope according to one embodiment of the present invention;

FIG. 4 is an example view illustrating another main view screen of a system for controlling an image data of an image sensor for a capsule endoscope according to one embodiment of the present invention;

FIG. 5 is an example view illustrating further another main view screen of a system for controlling an image data of an image sensor for a capsule endoscope according to one embodiment of the present invention;

FIG. 6 is an example view illustrating an alignment screen of a time axis among a state bar display of a system for controlling an image data of an image sensor for a capsule endoscope according to one embodiment of the present invention;

FIG. 7 is an example view illustrating an alignment screen of a frame among a state bar display of a system for controlling an image data of an image sensor for a capsule endoscope according to one embodiment of the present invention;

FIG. 8 is an example view illustrating an alignment screen of a time axis during integration of sensors among a state bar display of a system for controlling an image data of an image sensor for a capsule endoscope according to one embodiment of the present invention;

FIG. 9 is an example view illustrating an alignment screen of a frame during integration of sensors among a state bar display of a system for controlling an image data of an image sensor for a capsule endoscope according to one embodiment of the present invention;

FIG. 10 is an example view illustrating a screen during enlargement of information among a state bar display of a system for controlling an image data of an image sensor for a capsule endoscope according to one embodiment of the present invention;

FIG. 11 is an example view illustrating another screen during enlargement of information among a state bar display of a system for controlling an image data of an image sensor for a capsule endoscope according to one embodiment of the present invention;

FIG. 12 is an example view illustrating a display screen of a system for controlling an image data of an image sensor for a capsule endoscope according to another embodiment of the present invention;

FIG. 13 is an example view illustrating a display screen of a system for controlling an image data of an image sensor for a capsule endoscope according to further another embodiment of the present invention;

FIG. 14 is an example view illustrating a display screen of a system for controlling an image data of an image sensor for a capsule endoscope according to further another embodiment of the present invention; and

FIG. 15 is an example view illustrating a display screen of a system for controlling an image data of an image sensor for a capsule endoscope according to further another embodiment of the present invention;

### DESCRIPTIONS ON REFERENCE NUMBERS FOR THE MAJOR COMPONENTS IN THE DRAWINGS

100: system for controlling image data

110: image information receiving unit

120: image separating unit

130: mini view processing unit

140: main view processing unit

150: state information processing unit

160: central control unit

### BEST MODE

### Mode for Invention

In order to accomplish these objects, there is provided a system for controlling an image data of an image sensor for a capsule endoscope having a master image sensor and a slave image sensor for photographing an inside of animal bodies including a human body according to one embodiment of the present invention comprising:

an image information receiving unit for receiving image information transmitted from the master image sensor and the slave image sensor;

an image separating unit for dividing images transmitted from the master image sensor and the slave image sensor by analyzing the image information received from the image information receiving unit;

a mini view processing unit for outputting the image divided by the image separating unit to a master display region and a slave display region;

a main view processing unit for enlarging and outputting the image by enabling a user to choose one image from the images outputted from the mini view processing unit;

a state information processing unit for outputting the state of the image according to a sensor into a bar type by analyzing the image information received from the image information receiving unit; and

a central control unit for controlling the signal flow of the image information receiving unit, the image separating unit, the mini view processing unit, the main view processing unit, and the state information processing unit.

In order to accomplish these objects, there is provided a system for controlling an image data of an image sensor for a capsule endoscope having a master image sensor and a slave image sensor for photographing an inside of animal bodies including a human body according to another embodiment of the present invention comprising:

an image information receiving unit for receiving image information transmitted from the master image sensor and the slave image sensor;

an image separating unit for dividing images transmitted from the master image sensor and the slave image sensor by analyzing the image information received from the image information receiving unit;

a mini view processing unit for outputting the image divided by the image separating unit to a master display region and a slave display region;

a main view processing unit for enlarging and outputting the image by enabling a user to choose one image from the images outputted from the mini view processing unit;

a state information processing unit for outputting the state of the image according to a sensor into a bar type by analyzing the image information received from the image information receiving unit;

an image classification processing unit for classifying similar images adjacent to each other among the image information, which is received to the image information receiving unit, into one image group; and

a central control unit for controlling the signal flow of the image information receiving unit, the image separating unit, the mini view processing unit, the main view processing unit, the state information processing unit, and the image classification processing unit.

In order to accomplish these objects, there is provided a system for controlling an image data of an image sensor for a capsule endoscope having a master image sensor and a slave image sensor for photographing an inside of animal bodies including a human body according to further another embodiment of the present invention comprising:

an image information receiving unit for receiving image information transmitted from the master image sensor and the slave image sensor;

an image separating unit for dividing images transmitted from the master image sensor and the slave image sensor by analyzing the image information received from the image information receiving unit;

a state information processing unit for outputting the state of the image according to a sensor into a bar type by analyzing the image information divided by the image separating unit

a main view processing unit for processing and outputting a frame selected by a user through the state information processing unit; and

a central control unit for controlling the signal flow of the image information receiving unit, the image separating unit, the state information processing unit, and the main view processing unit.

In order to accomplish these objects, there is provided a system for controlling an image data of an image sensor for a capsule endoscope having a master image sensor and a slave image sensor for photographing an inside of animal bodies including a human body according to further another embodiment of the present invention comprising:

an image information receiving unit for receiving image information transmitted from the master image sensor and the slave image sensor;

an image separating unit for dividing images transmitted from the master image sensor and the slave image sensor by analyzing the image information received from the image information receiving unit;

a state information processing unit for outputting the state of the image according to a sensor into a bar type by analyzing the image information divided by the image separating unit

a main view processing unit for processing and outputting a frame selected by a user through the state information processing unit;

an image classification processing unit for classifying similar images adjacent to each other among the image information, which is received to the image information receiving unit, into one image group; and

a central control unit for controlling the signal flow of the image information receiving unit, the image separating unit, the state information processing unit, the main view processing unit, and the image classification processing unit.

At this time, the image photographed by the master image sensor is displayed on any one region of the main view and the image photographed by the slave image sensor is displayed on another region of the main view.

At this time, in the main view processing unit, the image of the master image sensor is listed on any one part and the past images are subsequently displayed on the right side thereof in chronological order, and the image of the slave image sensor is listed on another part and the future images are subsequently displayed on the left side thereof in chronological order.

At this time, in the main view processing unit, two sensor images are placed vertically and the past images and the future images are displayed on the left and right sides thereof around the current images.

At this time, in the main view processing unit, it can sort the view point of the two sensors if the synchronization point is found during a playback of the images.

At this time, the state information processing unit displays particular color bars of marking the location of the playback.

At this time, in the state information processing unit, the alignment of the time axis alignment is displayed by a bar graph by calculating the frames as time passed.

At this time, in the state information processing unit, the frames are aligned by the number of the frame to be displayed as a bar graph.

At this time, in the state information processing unit, during the alignment of the time axis, the frames are calculated as time passed by combining the master with the slave to be displayed as the bar graph and during the alignment of the frame, the frames are calculated as the number of the frame by combining the master with the slave to be displayed as the bar graph.

At this time, in the state information processing unit, the pH is displayed on any part of the bar by synchronizing the output of the pH sensor with the capsule photographing image and is displayed on the master image sensor and the slave image sensor in common and the average color of the photographic images is marked on the bar for organ division.

At this time, in the state information processing unit, the temperature is displayed on any part of the bar by synchronizing the output of the temperature sensor with the capsule photographing image and is displayed on the master image sensor and the slave image sensor in common.

At this time, in the state information processing unit, at least one of the pressure and the acceleration is displayed thereon, the output of the pressure sensor is displayed on any part of the bar by synchronizing the output of the pressure sensor with the capsule photographing image and is displayed on the master image sensor and the slave image sensor in common, and the output of the acceleration sensor is displayed on any part of the bar by synchronizing the output of the acceleration sensor with the capsule photographing image and is displayed on the master image sensor and the slave image sensor in common.

At this time, in the state information processing unit serves to extract at least one information among an image frame, a photographing speed, a location information, an Active/Sleep, an average color, an organ division, a moving speed, an image brightness, a pH, an acceleration, a temperature, a pressure, and display the extracted information as a status bar of a bar shape.

At this time, the image classification processing unit serves to display the number of the classified image frame, an average brightness, and a color sense in the form of a vertical bar or a horizontal bar.

At this time, in the image classification processing unit, two sensor images are synchronized to be classified and displayed and during operation of the sleep mode of the slave image sensor, only the image of the master image sensor is displayed.

At this time, in the image classification processing unit, each image of the master image sensor and the slave image sensor is independently classified to be displayed without synchronizing the master image sensor and the slave image sensor.

At this time, in the image classification processing unit, the main view is displayed with any one of two views and one view during selection of independent classification.

Hereinafter, an exemplary embodiment of the present invention will be described in detail with reference to the accompanying drawings.

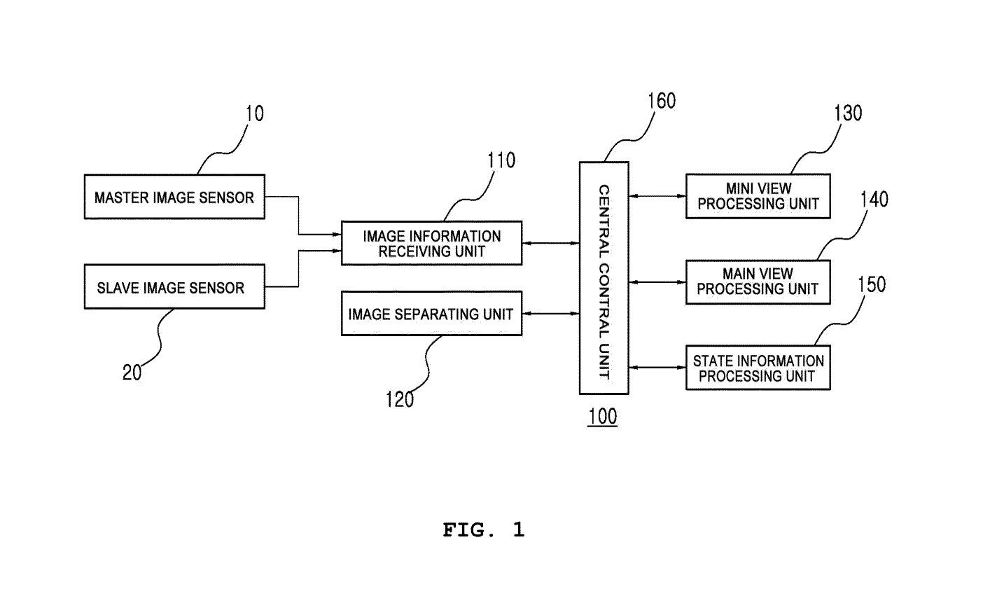

FIG. 1 is a block diagram illustrating a system for controlling an image data of an image sensor for a capsule endoscope according to one embodiment of the present invention.

As shown in FIG. 1, the system for controlling the image data of the image sensor for the capsule endoscope having a master image sensor and a slave image sensor for photographing an inside of animal bodies including a human body according to the present invention includes;

an image information receiving unit 110 for receiving image information transmitted from the master image sensor 10 and the slave image sensor 20;

an image separating unit 120 for dividing images transmitted from the master image sensor and the slave image sensor by analyzing the image information received from the image information receiving unit 110;

a mini view processing unit 130 for outputting the image divided by the image separating unit 120 to a master display region and a slave display region;

a main view processing unit 140 for enlarging and outputting the image by enabling a user to choose one image from the images outputted from the mini view processing unit 130;

a state information processing unit 150 for outputting the state of the image according to a sensor into a bar type by analyzing the image information received from the image information receiving unit 110; and

a central control unit 160 for controlling the signal flow of the image information receiving unit 110, the image separating unit 120, the mini view processing unit 130, the main view processing unit 140, and the state information processing unit 150.

As described above, there is characterized in that the system according to the present invention includes two image sensors, not one image sensor. Accordingly, two image sensors serves to alternatively block the operation of the internal circuit for the bi-directional photographing capsule endoscope, so that it can be operated by the low power, thereby completing the photography of the target organ through the capsule endoscope of the present invention. Also, the linkage operation and the controlling signal of two image sensors can be minimized and the operation of the image sensors designed and manufactured identically can be programmable, so that it can change the setting of the operation of the master and slave and the working speed of the image sensor for the specific duration, thereby providing the single mode operation, the dual mode operation, and the low power operation mechanism.

The construction and operation principle of the system having two image sensors are concretely described in the image sensor for a capsule endoscope enabling dual mode operation of Korean patent application No. 10-2010-40270, which is filed by the applicant of the present invention. Accordingly, a detailed description on this is omitted here.

The image information receiving unit 110 serves to receive the image information transmitted from the master image sensor 10 and the slave image sensor 20. Also, the image separating unit 120 serves to divide the image transmitted from the master image sensor and the slave image sensor by analyzing the image information received from the image information receiving unit 110.

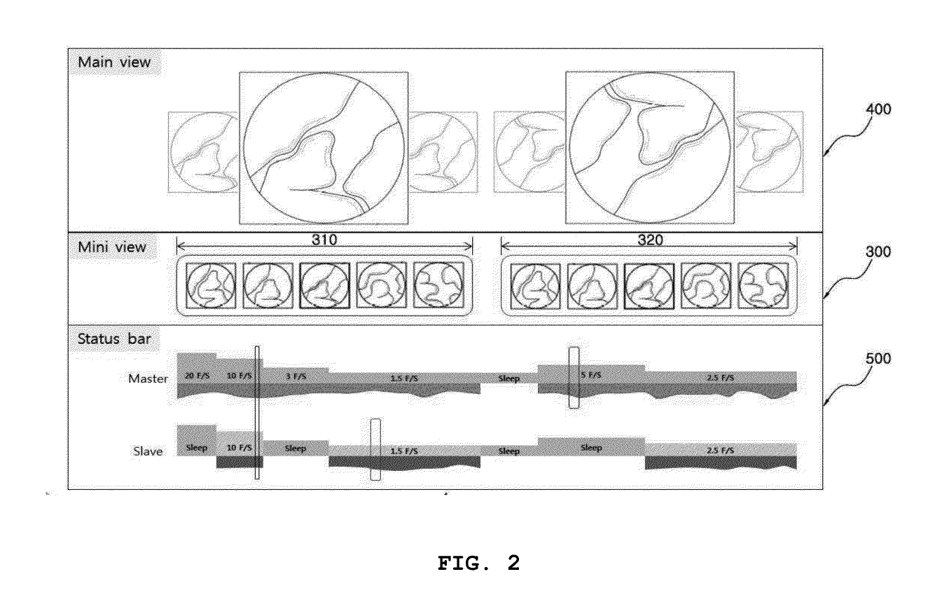

At this time, the mini view processing unit 130 serves to display the images divided by the image separating unit 120 on a mini view display region 300 shown in FIG. 2. Concretely, the mini view processing unit 130 serves to output the divided images to the master display region and the slave display region;

That is, the multiple images of each sensor are displayed thereon. Also, where the user selects the specific image, the selected image information is transmitted to the main view processing unit 140.

The main view processing unit 140 serves to enlarge and output the image by enabling a user to choose one image from the images outputted from the mini view processing unit 130.

Concretely, as shown in FIG. 2, the selected image information is enlarged and displayed on the main view display region 400.

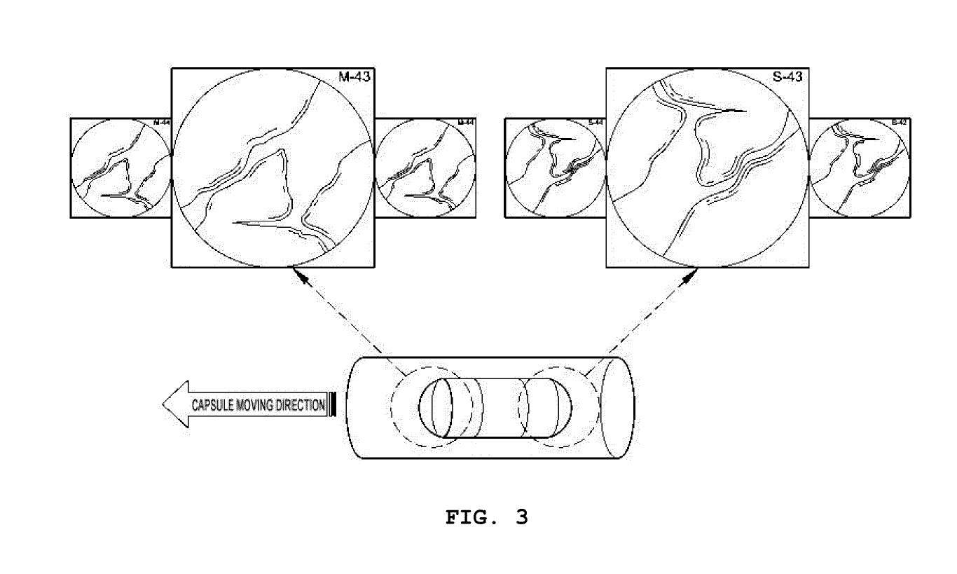

Two image sensors are utilized in the present invention. That is, as shown in FIG. 3, since the master image sensor is located in the front of the moving direction of the capsule and the slave image sensor is located in the rear of the moving direction of the capsule, the image photographed by the master image sensor is displayed on the left region of the main view and the image photographed by the slave image sensor is displayed on the right region of the main view.

In addition, the images M-43 and S-43, which are selected by a doctor, are enlarged and displayed thereon. Also, the front and the rear images M-44, M-42, S-44, and S-42 of the current images M-43 and S-43 are displayed from side to side respectively.

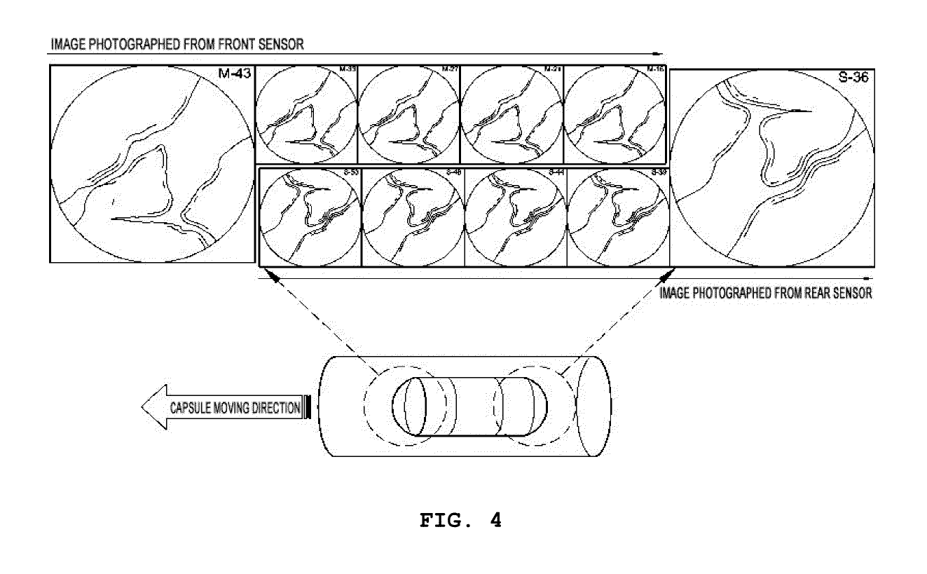

On the other hand, according to another function of the main view processing unit 140, as shown in FIG. 4, the image of the master image sensor progressed from the front thereof is listed on any one part, for example, the left side and the past images are subsequently displayed on the right side thereof in chronological order. Also, the image of the slave image sensor progressed from the rear thereof is listed on another part, for example, the right side and the future images are subsequently displayed on the left side thereof in chronological order.

In the display method as described above, the past images of the master image sensor and the future images of the slave image sensor are compared with each other and the same points are displayed by the sensors to be synchronized.

In this case, the images of the same point photographed in a different direction can be checked at a time, thereby more efficiently examining the images by means of the doctor.

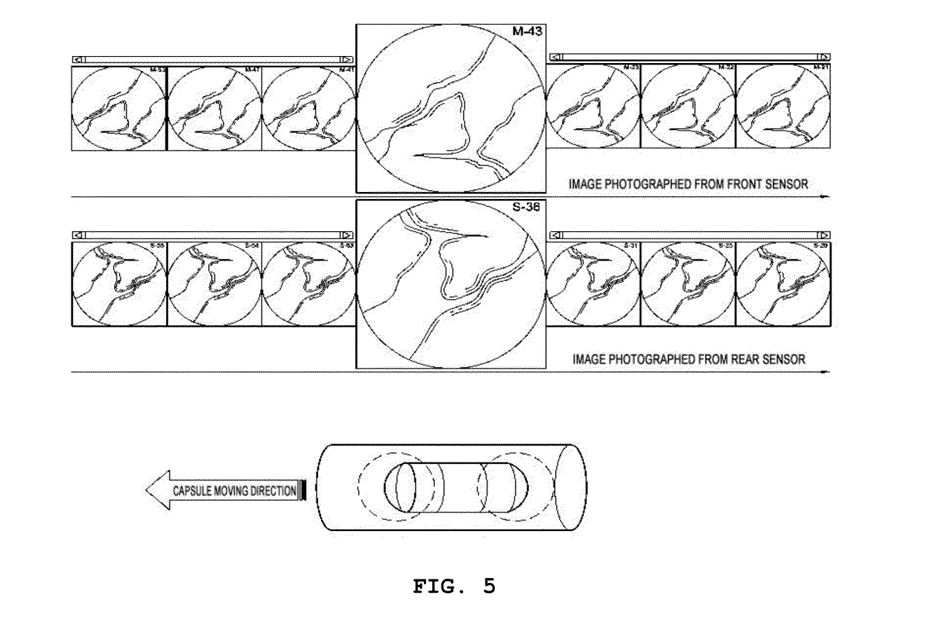

On the other hand, according to further another function of the main view processing unit 140, as shown in FIG. 5, two sensor images are placed vertically. That is, the past images and the future images are displayed on the left and right sides thereof around the current images M-36 and S-36.

The sufficient numbers of the past and future images of each sensor are displayed thereon in consideration of the temporal synchronization of the master image sensor and the slave image sensor. Also, the images can be displayed through a scroll. Accordingly, the doctor can find a more accurate synchronization point.

In addition, where two sensor images are placed vertically and the past images and the future images are displayed on the left and right sides thereof around the current images M-36 and S-36, if the synchronization point is found during a playback of the images, it can perform the function to set and sort the view point of the two sensors.

Accordingly, since the synchronization point can freely changed during the image playback, the doctor can analyse the images more easily.

To explain the schematic operation of the main view processing unit 140, it serves to process the image information data and divide the image information transmitted from the master image sensor and the slave image sensor to be displayed thereon. At this time, according to the computer mouse control of the doctor, the central control unit 160 serves to receive the image information and then, the display is synchronized according to the process of the central control unit 160. Also, the mini view and the state bar are synchronized through the process of the central control unit 160 according to the synchronization of the display. These synchronization technologies are widely known in the art, further descriptions on these are omitted here.

The state information processing unit 150 serves to output the state of the image according to the sensor into the bar type by analyzing the image information received from the image information receiving unit 110.

As shown in FIG. 2, the state information processing unit 150 serves to display the state of the image according to the sensor on a state information display region 500 in the shape of the bar by analyzing the image information received from the image information receiving unit 110.

The state of the entire photographed images is outputted according to the image sensor into the bar type. In the present invention, because the two sensors are constructed, two bars are displayed thereon. However, if three sensors are constructed, three bars are displayed thereon.

Also, the state information of a photographic speed, a frame rate, a brightness, an organ indicators, a pH, a temperature etc. can be displayed on the state information display region 500. Moreover, it constitutes the bars to indicate the position of currently playing.

In the present invention, the area marked on the mini view among the areas captured by the master image sensor is expressed as a red bar and the area marked on the mini view among the areas captured by the slave image sensor is expressed as a blue bar.

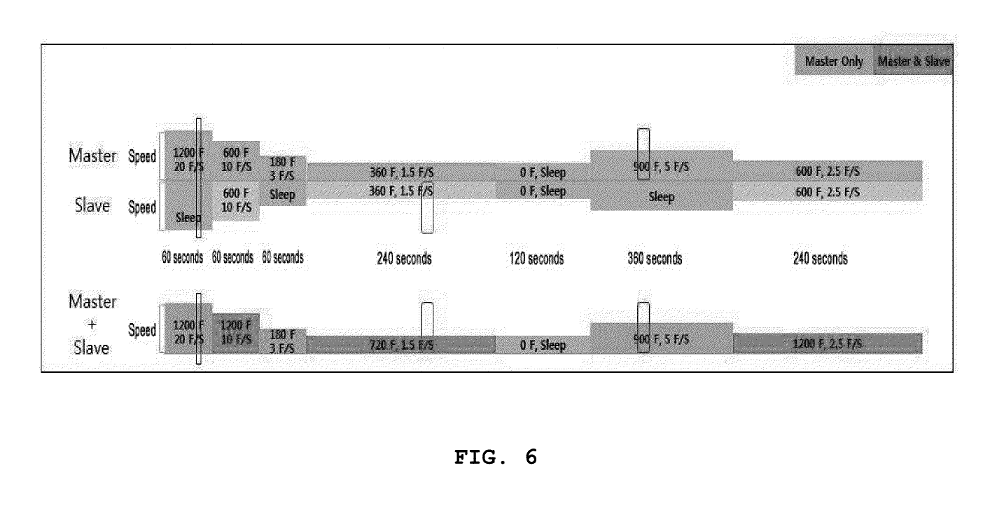

FIG. 6 illustrates an alignment of the time axis. Here, the speed means the photographic speed.

Specifically, the state of the entire images photographed by the capsule is displayed in the type of the bar. It displays particular color bars of marking the location of the playback.

The state of the sensor, that is, the operational speed, the Active/Sleep etc. is separately displayed thereon.

The alignment of the time axis alignment is displayed by a bar graph by calculating the frames as time passed. Accordingly, the doctor can easily recognize and analyse the time progress and the photographic speed.

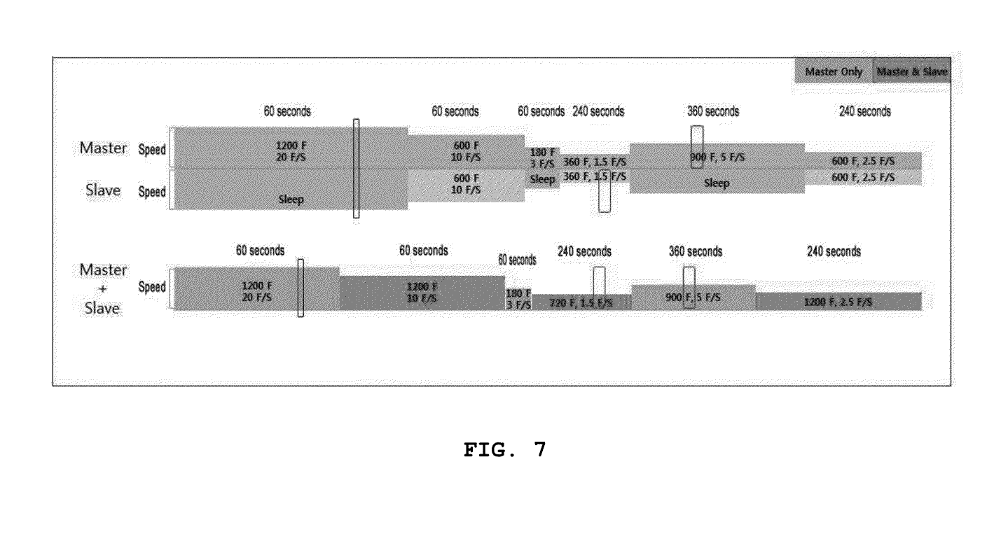

FIG. 7 illustrates an alignment of the frame. Here, the speed means the photographic speed.

In the alignment of the frame, the frames are aligned by the number of the frame to be displayed as a bar graph. That is, only the images photographed regardless of the photographic speed of the capsule and the time progress are listed thereon.

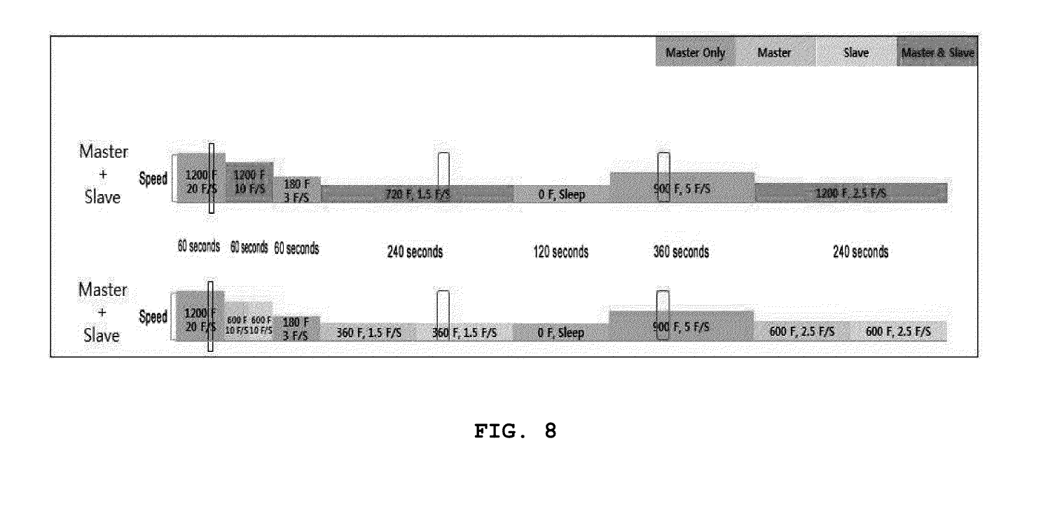

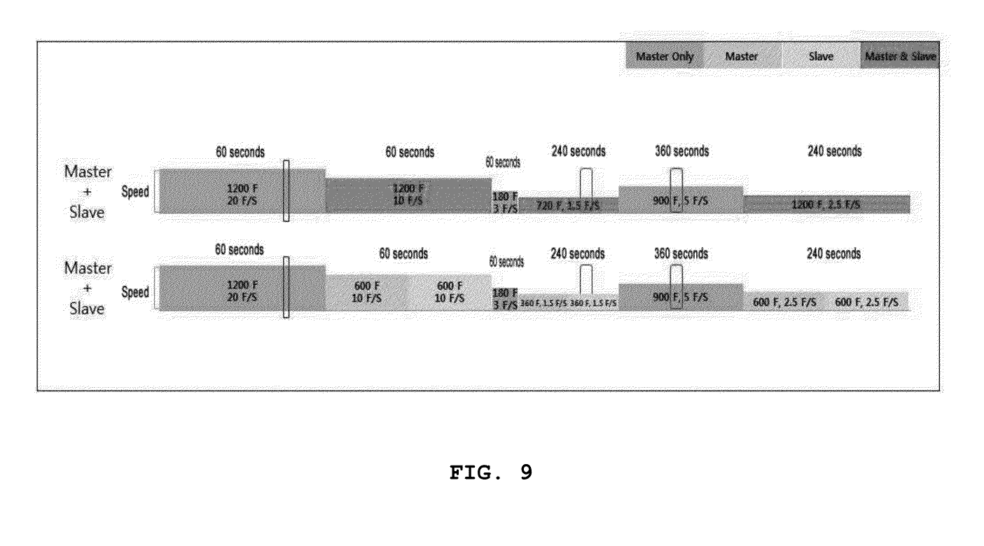

On the other hand, in accordance with another function of the state information processing unit 150, as shown in FIG. 8, during the alignment of the time axis, the frames are calculated as time passed by combining the master with the slave to be displayed as the bar graph. Also, in accordance with further another function of the state information processing unit 150, as shown in FIG. 9, during the alignment of the frame, the frames are calculated as the number of the frame by combining the master with the slave to be displayed as the bar graph.

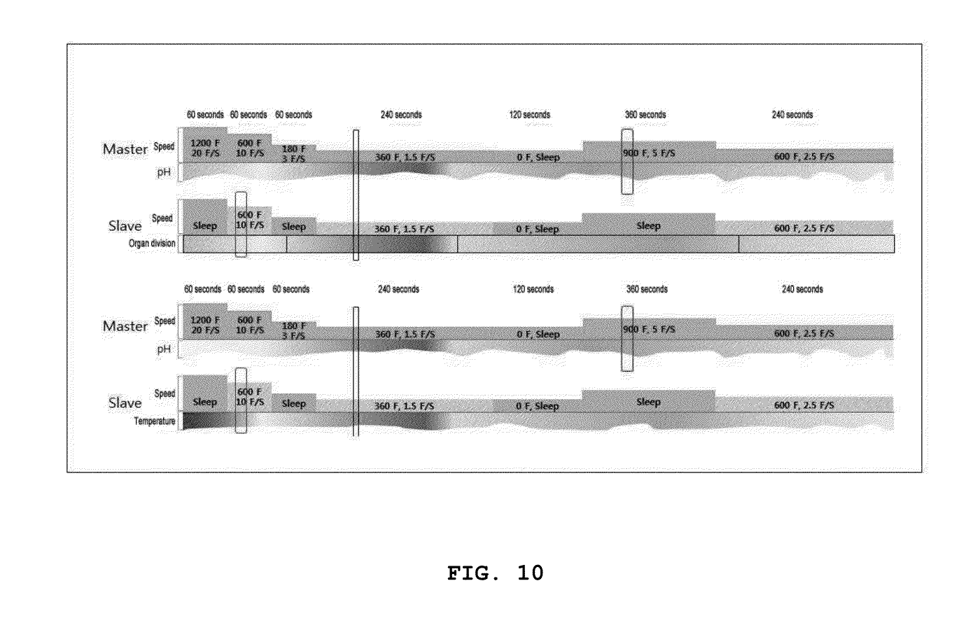

On the other hand, in accordance with further another function of the state information processing unit 150, as shown in FIG. 10, the state bar is enlarged to be displayed thereon.

That is, each of the sensor information is displayed on the lower end portion of the bar.

The speed shown in FIG. 10 is the photographic speed, the pH means an acidity, and the organs are divided according to the color and the shape. Also, the temperature means the value of the output of the temperature sensor.

The temperature sensor is typically mounted on the capsule endoscopy and the colors thereof are changed according to the value of the output of the temperature sensor.

The pH is displayed on any part of the bar by synchronizing the output of the pH sensor with the capsule photographing image and is displayed on the master image sensor and the slave image sensor in common.

In order to mark the acidity, the pH sensor is constructed in the capsule endoscopy.

As described above, it can measure the acidity of the body and check out the relationship between the symptoms of a disease and the acidity through a monitor.

The average color of the photographic images is marked on the bar and the organs are divided according to the average color and the shape of the organ. Accordingly, the doctor can confirm the distribution of the organ images at a look.

The temperature is displayed on any part of the bar by synchronizing the output of the temperature sensor with the capsule photographing image and is displayed on the master image sensor and the slave image sensor in common.

Accordingly, it can measure the temperature of the body and check out the relationship between the symptoms of a disease and the body temperature.

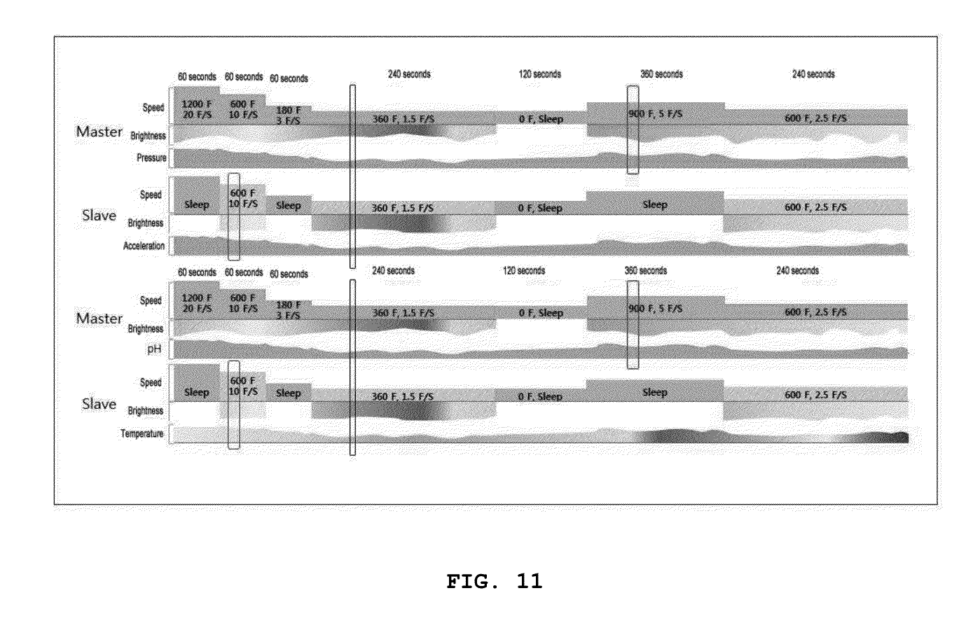

On the other hand, in accordance with further another function of the state information processing unit 150, as shown in FIG. 11, the state bar is enlarged to be displayed thereon.

The speed shown in FIG. 11 is the photographic speed, the pH means an acidity, and the organs are divided according to the color and the shape. Also, the temperature means the value of the output of the temperature sensor. Also, an acceleration thereof is displayed. Here, the acceleration means the output of an acceleration sensor.

Moreover, a pressure is displayed. Here, the pressure means the output of a pressure sensor means.

In addition, the acceleration sensor and the pressure sensor and the temperature sensor are formed in the capsule of the present invention.

That is, at least one of the pressure and the acceleration is displayed thereon.

The output of the pressure sensor is displayed on any part of the bar by synchronizing the output of the pressure sensor with the capsule photographing image and is displayed on the master image sensor and the slave image sensor in common.

Accordingly, it can measure the exercise capacity of the human organ and be used in the organ division. Also, it can be utilized in the organ activity and the motor examination.

Also, the output of the acceleration sensor is displayed on any part of the bar by synchronizing the output of the acceleration sensor with the capsule photographing image and is displayed on the master image sensor and the slave image sensor in common.

Accordingly, the posture and moving speed of the capsule are checked out, so that it can distinguish the master image sensor and the slave image sensor and be used as supplementary materials of the position recognition.

To explain the schematic operation of the state information processing unit 150, it serves to process the image information data, extract the information such as an image frame, a photographing speed, a location information, an Active/Sleep, an average color, an organ division, a moving speed, an image brightness, a pH, an acceleration, a temperature, a pressure, and display the extracted information as a status bar of a bar shape.

At this time, the doctor can check out the images and information of a desiring moment through a click of a computer mouse.

In addition, the system according to an additional aspect of the present invention further includes an image classification processing unit (not shown) for classifying similar images adjacent to each other among the image information, which is received to the image information receiving unit 110, into one image group.

That is, the adjacent images are combined into one image group, only one is listed, and the number of the images belonging to the image group is displayed thereon.

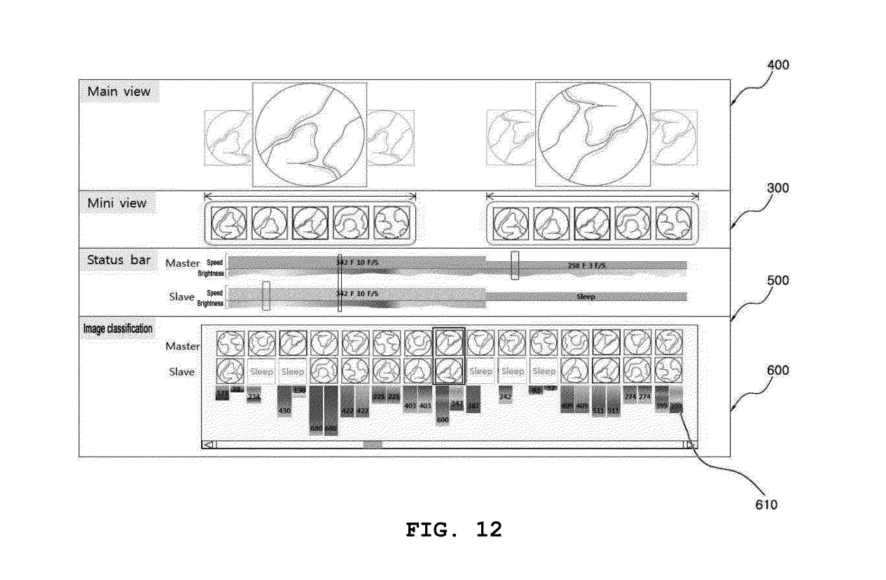

As shown in FIG. 12, the image classification processing unit serves to bind the similar images among the image information, which is received to the image information receiving unit 110, as one image group and list them on an image classification display region 600 to be displayed.

Also, the image classification processing unit serves to compare a shape (Edge) of the image, a brightness, a color, and the results of the master image sensor/the slave sensor to classify the images.

In addition, the number of the classified image frame, an average brightness, and a color sense are displayed in the form of a vertical bar 610.

Two sensor images are synchronized to be classified and displayed. During operation of the sleep mode of the slave image sensor, only the image of the master image sensor is displayed.

According to the above display method, it binds the similar images together and the characteristic images are listed, so that the examination time of the doctor can be shortened.

In the above display method, it has basically 2 view manner.

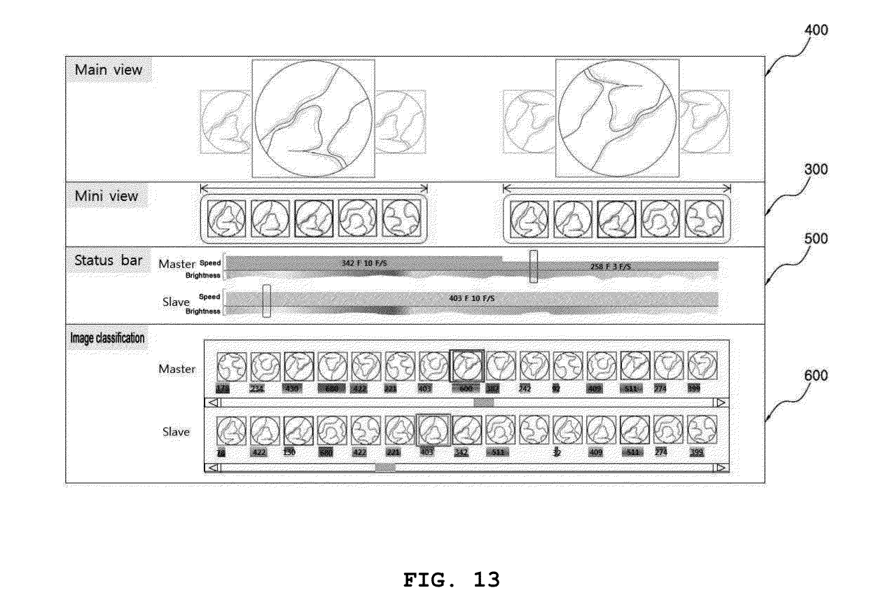

On the other hand, FIG. 13 illustrates another embodiment.

That is, without synchronizing the master image sensor and the slave image sensor, each image of the master image sensor and the slave image sensor is separately (independently) classified to be displayed.

As described above, since the images are independently classified, it can provide independently selectable features. Also, it is characterized in that the sleep modes on all of the sensors are not considered.

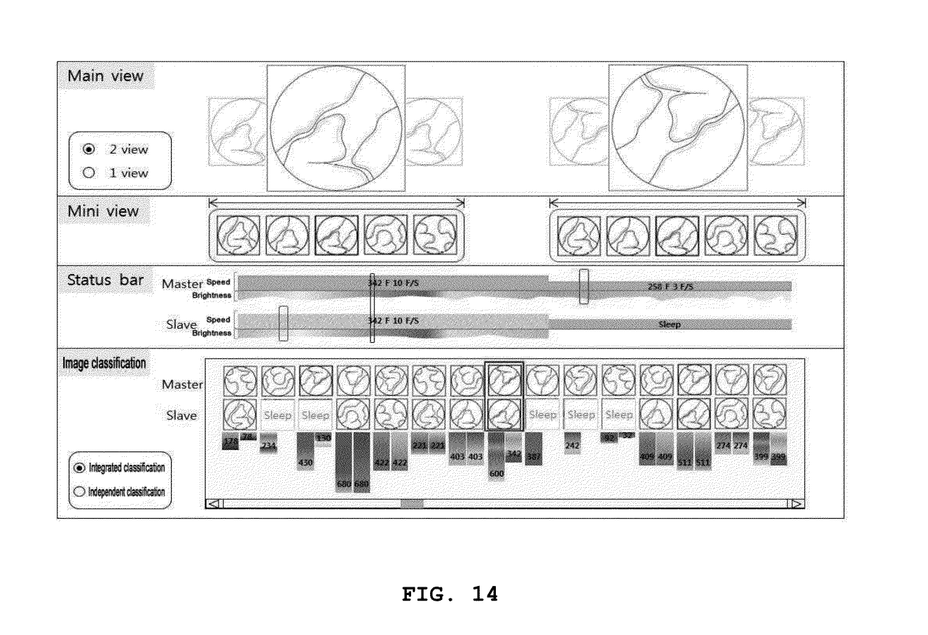

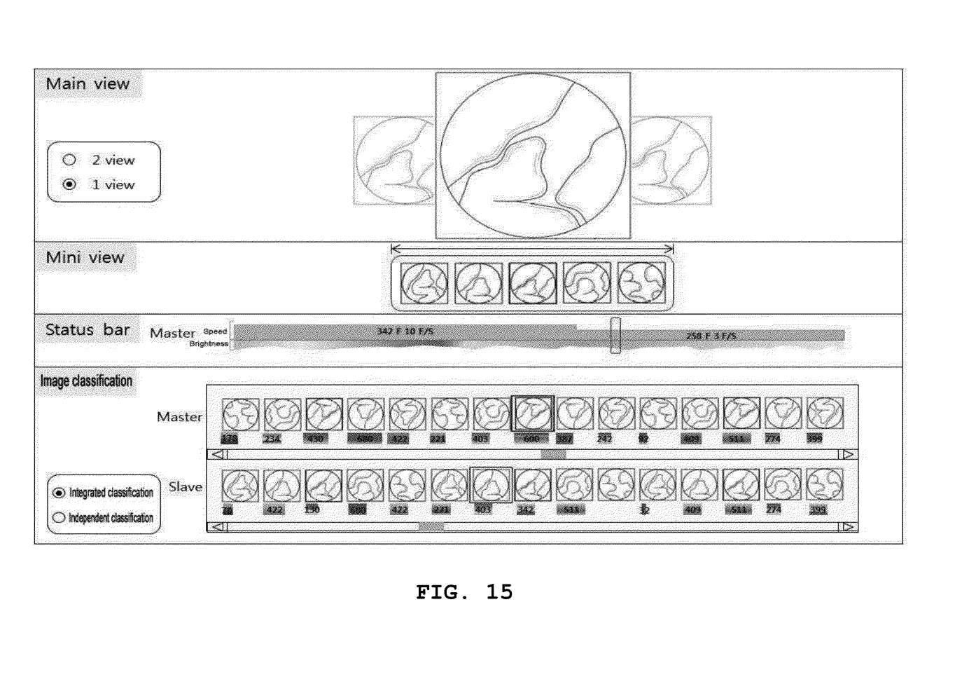

In the independent classification, basically, the main view adopts two views. However, one view is also available (note FIG. 14 and FIG. 15).

Accordingly, it can classify the similar images, thereby shortening the examination time, the synchronization between the sensors can be freely adjusted, thereby analyzing the images, and it can intensively analyze the images in a short period of time by using one view mode.

To explain the schematic operation of the image classification processing unit, it serves to unify the images photographed by the master image sensor and the slave image sensor according to the similarity or independently classify them. Also, it serves to display them as a vertical bar or a horizontal bar of expressing the number of the classified images and the average brightness.

In the meantime, a system for controlling an image data of an image sensor for a capsule endoscope according another embodiment of the present invention includes;

an image information receiving unit for receiving image information transmitted from the master image sensor and the slave image sensor;

an image separating unit for dividing images transmitted from the master image sensor and the slave image sensor by analyzing the image information received from the image information receiving unit;

a state information processing unit for outputting the state of the image according to a sensor into a bar type by analyzing the image information divided by the image separating unit

a main view processing unit for processing and outputting a frame selected by a user through the state information processing unit; and

a central control unit for controlling the signal flow of the image information receiving unit, the image separating unit, the state information processing unit, and the main view processing unit.

That is, without the mini view, the frames (images) selected by the user are outputted to the main view through the bars, which are processed by the state information processing unit.

According to the system for controlling the image data of the image sensor for the capsule endoscope, there is an effect in that the capsule photographing images, the operating speed of the capsule, and the information thereof are unified to be displayed, thereby easily examining the photographed images by means of a doctor, and especially the information such as the operating speed of the capsule and the on/off status of the image sensor is displayed with photographing images of the body in the form of the bar graph so as to unify the photographed image of the inside of the body.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention relates to a system for controlling an image data of an image sensor for a capsule endoscope, which controls the image data of a capsule endoscope system in which operations are changed using two image sensors of a capsule endoscope that are identically designed and manufactured in order to capture images of the inside of the human body, thereby being effectively utilized in the field of the endoscope.

1. A system for controlling an image data of an image sensor for a capsule endoscope having a master image sensor and a slave image sensor for photographing an inside of animal bodies including a human body comprising:
an image information receiving unit for receiving image information transmitted from the master image sensor and the slave image sensor;
an image separating unit for dividing images transmitted from the master image sensor and the slave image sensor by analyzing the image information received from the image information receiving unit;
a mini view processing unit for outputting the image divided by the image separating unit to a master display region and a slave display region;
a main view processing unit for enlarging and outputting the image by enabling a user to choose one image from the images outputted from the mini view processing unit;
a state information processing unit for outputting the state of the image according to a sensor into a bar type by analyzing the image information received from the image information receiving unit; and
a central control unit for controlling the signal flow of the image information receiving unit, the image separating unit, the mini view processing unit, the main view processing unit, and the state information processing unit.

2. A system for controlling an image data of an image sensor for a capsule endoscope having a master image sensor and a slave image sensor for photographing an inside of animal bodies including a human body comprising:
an image information receiving unit for receiving image information transmitted from the master image sensor and the slave image sensor;
an image separating unit for dividing images transmitted from the master image sensor and the slave image sensor by analyzing the image information received from the image information receiving unit;
a mini view processing unit for outputting the image divided by the image separating unit to a master display region and a slave display region;
a main view processing unit for enlarging and outputting the image by enabling a user to choose one image from the images outputted from the mini view processing unit;
a state information processing unit for outputting the state of the image according to a sensor into a bar type by analyzing the image information received from the image information receiving unit;
an image classification processing unit for classifying similar images adjacent to each other among the image information, which is received to the image information receiving unit, into one image group; and
a central control unit for controlling the signal flow of the image information receiving unit, the image separating unit, the mini view processing unit, the main view processing unit, the state information processing unit, and the image classification processing unit.

3. A system for controlling an image data of an image sensor for a capsule endoscope having a master image sensor and a slave image sensor for photographing an inside of animal bodies including a human body comprising:
an image information receiving unit for receiving image information transmitted from the master image sensor and the slave image sensor;
an image separating unit for dividing images transmitted from the master image sensor and the slave image sensor by analyzing the image information received from the image information receiving unit;
a state information processing unit for outputting the state of the image according to a sensor into a bar type by analyzing the image information divided by the image separating unit
a main view processing unit for processing and outputting a frame selected by a user through the state information processing unit; and
a central control unit for controlling the signal flow of the image information receiving unit, the image separating unit, the state information processing unit, and the main view processing unit.

4. A system for controlling an image data of an image sensor for a capsule endoscope having a master image sensor and a slave image sensor for photographing an inside of animal bodies including a human body comprising:
an image information receiving unit for receiving image information transmitted from the master image sensor and the slave image sensor;
an image separating unit for dividing images transmitted from the master image sensor and the slave image sensor by analyzing the image information received from the image information receiving unit;
a state information processing unit for outputting the state of the image according to a sensor into a bar type by analyzing the image information divided by the image separating unit
a main view processing unit for processing and outputting a frame selected by a user through the state information processing unit;
an image classification processing unit for classifying similar images adjacent to each other among the image information, which is received to the image information receiving unit, into one image group; and
a central control unit for controlling the signal flow of the image information receiving unit, the image separating unit, the state information processing unit, the main view processing unit, and the image classification processing unit.

5. A system for controlling an image data of an image sensor for a capsule endoscope as claimed in claim 1, wherein the image photographed by the master image sensor is displayed on any one region of the main view and the image photographed by the slave image sensor is displayed on another region of the main view.

6. A system for controlling an image data of an image sensor for a capsule endoscope as claimed in claim 1, wherein, in the main view processing unit, the image of the master image sensor is listed on any one part and the past images are subsequently displayed on the right side thereof in chronological order, and the image of the slave image sensor is listed on another part and the future images are subsequently displayed on the left side thereof in chronological order.

7. A system for controlling an image data of an image sensor for a capsule endoscope as claimed in claim 1, wherein, in the main view processing unit, two sensor images are placed vertically and the past images and the future images are displayed on the left and right sides thereof around the current images.

8. A system for controlling an image data of an image sensor for a capsule endoscope as claimed in claim 1, wherein, in the main view processing unit, it can sort the view point of the two sensors if the synchronization point is found during a playback of the images.

9. A system for controlling an image data of an image sensor for a capsule endoscope as claimed in claim 1, wherein the state information processing unit displays particular color bars of marking the location of the playback.

10. A system for controlling an image data of an image sensor for a capsule endoscope as claimed in claim 1, wherein, in the state information processing unit, the alignment of the time axis alignment is displayed by a bar graph by calculating the frames as time passed.

11. A system for controlling an image data of an image sensor for a capsule endoscope as claimed in claim 1 wherein, in the state information processing unit, the frames are aligned by the number of the frame to be displayed as a bar graph.

12. A system for controlling an image data of an image sensor for a capsule endoscope as claimed in claim 1, wherein, in the state information processing unit, during the alignment of the time axis, the frames are calculated as time passed by combining the master with the slave to be displayed as the bar graph and during the alignment of the frame, the frames are calculated as the number of the frame by combining the master with the slave to be displayed as the bar graph.

13. A system for controlling an image data of an image sensor for a capsule endoscope as claimed in claim 1, wherein, in the state information processing unit, the pH is displayed on any part of the bar by synchronizing the output of the pH sensor with the capsule photographing image and is displayed on the master image sensor and the slave image sensor in common and the average color of the photographic images is marked on the bar for organ division.

14. A system for controlling an image data of an image sensor for a capsule endoscope as claimed in claim 1, wherein, in the state information processing unit, the temperature is displayed on any part of the bar by synchronizing the output of the temperature sensor with the capsule photographing image and is displayed on the master image sensor and the slave image sensor in common.

15. A system for controlling an image data of an image sensor for a capsule endoscope as claimed in claim 1, wherein, in the state information processing unit, at least one of the pressure and the acceleration is displayed thereon, the output of the pressure sensor is displayed on any part of the bar by synchronizing the output of the pressure sensor with the capsule photographing image and is displayed on the master image sensor and the slave image sensor in common, and the output of the acceleration sensor is displayed on any part of the bar by synchronizing the output of the acceleration sensor with the capsule photographing image and is displayed on the master image sensor and the slave image sensor in common.

16. A system for controlling an image data of an image sensor for a capsule endoscope as claimed in claim 1, wherein, in the state information processing unit serves to extract at least one information among an image frame, a photographing speed, a location information, an Active/Sleep, an average color, an organ division, a moving speed, an image brightness, a pH, an acceleration, a temperature, a pressure, and display the extracted information as a status bar of a bar shape.

17. A system for controlling an image data of an image sensor for a capsule endoscope as claimed in claim 2, wherein the image classification processing unit serves to display the number of the classified image frame, an average brightness, and a color sense in the form of a vertical bar or a horizontal bar.

18. A system for controlling an image data of an image sensor for a capsule endoscope as claimed in claim 2, wherein, in the image classification processing unit, two sensor images are synchronized to be classified and displayed and during operation of the sleep mode of the slave image sensor, only the image of the master image sensor is displayed.

19. A system for controlling an image data of an image sensor for a capsule endoscope as claimed in claim 2, wherein, in the image classification processing unit, each image of the master image sensor and the slave image sensor is independently classified to be displayed without synchronizing the master image sensor and the slave image sensor.

20. A system for controlling an image data of an image sensor for a capsule endoscope as claimed in claim 2, wherein, in the image classification processing unit, the main view is displayed with any one of one view and two view during selection of independent classification.
